(19) United States
(12) Patent Application Publication
(10) Pub. No.: US 2013/0104561 A1
(43) Pub. Date: May 2, 2013

(54) ACTIVE FUEL CONTROL ON GAS TURBINE SHUTDOWN SEQUENCE

(71) Applicants: Gerardo Fidel Varillas, Greenville, SC (US); Bradley Steven Carey, Greer, SC (US); Kevin Michael Elward, Simpsonville, SC (US); John Edward Pritchard, Simpsonville, SC (US)

(72) Inventors: Gerardo Fidel Varillas, Greenville, SC (US); Bradley Steven Carey, Greer, SC (US); Kevin Michael Elward, Simpsonville, SC (US); John Edward Pritchard, Simpsonville, SC (US)

(73) Assignee: GENERAL ELECTRIC COMPANY, Schenectady, NY (US)

(21) Appl. No.: 13/285,415

(22) Filed: Oct. 31, 2011

(51) Int. Cl. F02C 9/26

(52) U.S. Cl. 60/773; 60/39.281

(57) ABSTRACT

A method, system and generator for controlling a flow of fuel during a shut down of a gas turbine generator is disclosed. A first fuel flow rate to a combustion flame of the gas turbine generator is set at a beginning of a shut-down sequence. A sensor is configured to measure a rotation rate of a turbine rotor of the generator. A processor determines a deceleration of the turbine rotor from the measured rotation rates corresponding to the first fuel flow rate and compares the determined deceleration to a selected criterion. When the deceleration matches the selected criterion, the processor adjusts the fuel flow rate from the first fuel flow rate to a second fuel flow rate.

### BACKGROUND OF THE INVENTION

The subject matter disclosed herein relates to methods of shutting down a gas turbine. Gas turbines are typically shut-down over a period of time that begins by reducing a fuel flow rate from an operational fuel flow rate. During this shut-down period, the turbine rotor begins to decelerate and a combustion flame held in the combustor of the gas turbine is gradually diminished as the airflow caused by the rotating turbine rotor is gradually decreased. The flow rate of fuel to the combustor is generally decreased to reduce the combustion flame and thus the turbine rotor speed. However, often the generator can “hang” where the turbine rotor substantially stops decelerating, thus lengthening the duration of the shut-down sequence. These hangs are to be avoided, as it is useful to shut down the generator in as short a time as possible. The present disclosure therefore provides a method for shutting down a gas turbine using a closed-loop feedback.

### BRIEF DESCRIPTION OF THE INVENTION

According to one aspect of the invention, a method of shutting down a gas turbine generator is disclosed. The method includes setting a first fuel flow rate to a combustion flame of the gas turbine generator; determining a deceleration of a rotor of the gas turbine generator corresponding to the first fuel flow rate; comparing the deceleration to a selected criterion; and adjusting the first fuel flow rate to a second fuel flow rate when the deceleration matches the selected criterion.

According to another aspect of the invention, a system for shutting down a gas turbine generator is disclosed. The system includes a sensor configured to measure a rotation rate of a turbine rotor of the gas turbine generator; and a processor configured to: determine a deceleration of the turbine rotor from the measured rotation rates corresponding to a first fuel flow rate, compare the determined deceleration to a selected criterion, and adjust the fuel flow rate when the deceleration matches the selected criterion.

According to yet another aspect of the invention, a generator is disclosed that includes: a turbine section having a rotor having a plurality of turbine blades; a combustor configured to burn a fuel to produce a working gas for rotating the rotor of the turbine section; and a processor configured to: set a first fuel flow rate at the combustor at the beginning of shut-down sequence, determine a deceleration of the rotor at the first fuel flow rate, compare the determined deceleration to a selected criterion, and adjust the first fuel flow rate to a second fuel flow rate when the determined deceleration matches the selected criterion.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary generator system of the present disclosure;

FIG. 2 shows a graph of various parameters with respect to time of an open-loop shut-down sequence in one embodiment;

FIG. 3 shows a graph of various parameters with respect to time for an exemplary closed-loop shut-down sequence in an embodiment of the present disclosure; and

FIG. 4 shows a flowchart of an exemplary method of the present disclosure for shutting down the generator.

The detailed description explains embodiments of the invention, together with advantages and features, by way of example with reference to the drawings.

### DETAILED DESCRIPTION OF THE INVENTION

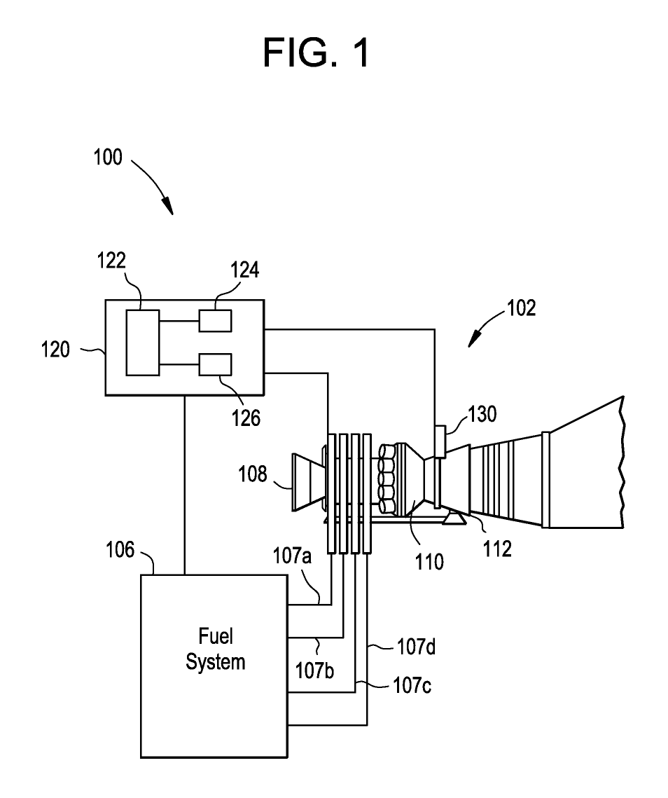

FIG. 1 shows an exemplary generator system 100 of the present disclosure for generating power. The generator system 100 can, in one embodiment, be employed as part of a combined cycle power plant to produce electricity. The exemplary generator system includes an exemplary gas turbine 102 that includes a compressor section 108, a combustion section 110 and a turbine section 112. The compressor section 108 includes a series of compressor stages, each stage including a plurality of compressor blades that rotate to compress air. The compressor section 108 generally receives ambient air at an inlet to the compressor section, compresses the air at the compressor stages and provides the compressed air at the outlet of the compressor section to the combustion section 110. In the combustion section 110, fuel from the fuel system 106 is mixed with the compressed air from the compressor. The air/fuel mixture is then ignited using an ignition device such as a spark plug to create a working gas. The working gas is directed through the turbine section 112. The turbine section 112 is made up of a serial arrangement of stages, each stage having rotating blades known as buckets. The rotating buckets are supported by a common rotary shaft, also referred to herein as a rotor or a turbine rotor. The working gas exiting the combustion section 110 expands through the serial stages to cause rotation of the buckets and therefore of the turbine rotor. In one aspect, the turbine rotor of the turbine section 112 can be connected to the compression blades in the compressor section so that rotation of the turbine rotor drives air compression in the compressor section 108. The compressor blades and the turbine blades therefore rotate at the same speed. The rotary shaft also extends beyond the turbine section to a generator (not shown) where the rotary motion of the rotary shaft is converted into electrical power. In an embodiment in which the generator is used as part of a combined cycle power plant, the exhausted working gas from the turbine section 112 is directed toward a heat recovery steam generator to power a steam cycle for electricity generation.

The generator system 100 further includes a fuel system 106 for providing fuel to the gas turbine generator for burning in the combustion section 110. As shown in FIG. 1, four fuel lines 107a, 107b, 107c and 107d provide fuel from the fuel system 106 to the gas turbine 102. The number of fuel lines is not meant as a limitation of the disclosure and any number of fuel lines can be used in various embodiments of the disclosure. The fuel system is typically operated to provide fuel according to one mode of operation for startup of the gas turbine, according to another mode of operation for running the gas turbine and according to yet another mode of operation for shutting down of the gas turbine.

In an exemplary embodiment, the gas turbine 102 and fuel system 106 are coupled to a control unit 120 configured to control of various operations of the fuel system and gas turbine. The control unit 120 includes a memory 124, a set of programs 126 storing instructions therein for shutting down the generator 100 according to the methods described herein, and a processor 122 having access to the set of programs 146 and to the contents of the database 124. The processor 122 is configured to run the various programs for shutting down the gas turbine generator, as disclosed herein. The control unit can control valve configurations at the fuel system 106 in order to control a fuel flow rate in the fuel lines 107a-d. The control unit can also monitor various parameters, such as pressure at the fuel system 106, gas turbine temperature, rotation rate of the rotor of the turbine section 112, etc. that are affected by the fuel flow rate and adjusts the fuel flow rate using the monitored parameter.

A sensor 130 is coupled to the turbine section 112 to measure a parameter of the gas turbine. This sensor can be located at any point in turbine section 112 or compressor section 108. The parameter in various embodiments is a rotation speed of the rotor of the turbine section 112, but other suitable parameters can also be measured. The parameter can be provided to the processor 120 which typically determines a sequence for shutting down the generator 100 according to the methods disclosed herein.

The present disclosure provides a method for shutting down the exemplary gas turbine. A shutdown sequence generally occurs over a duration of time. The shutdown sequence is initiated by reducing a flow rate of fuel into the combustor from an online flow rate to a flow rate that sustains a combustion flame in the combustor. The shutdown sequence is completed when the combustion flame is extinguished, which is referred to as “flame-out.” During shut-down, compressor blades (which are generally still rotating) provide an airflow through the combustor that maintains the combustion flame until, by gradual slowing of the rotation of the rotor and its turbine blades, a parameter of the airflow (i.e., velocity, pressure) drops below a threshold for sustaining the combustion flame. The rotation rate and deceleration of the turbine rotor during the shut down sequence are affected by the amount of working gas provided by the residual combustion flame, which is in turn affected by the residual airflow and fuel flow rate to the combustion chamber. Typically, the fuel flow rate is adjusted during the shut-down sequence until flame-out. In typical operations, the fuel flow rate is adjusted according to a predetermined shut-down sequence. This is often referred to as an open loop method, since there is no feedback used to control the fuel flow rate. Typically, the predetermined shut-down sequence is designed for a particular gas turbine and is not applicable to another gas turbine.

The present disclosure provides a closed-loop shut-down sequence that provides feedback useful for adjusting a fuel flow rate to the combustion flame. In the closed-loop shutdown sequence, the sensor 130 measures the rotation rate of the turbine rotor or other suitable parameter and provides the measured rotation rates to the control unit 120 as feedback. The control unit determines deceleration from the measured rotation rates. The determined deceleration is used to determine a subsequent fuel flow rate to the combustor.

In one aspect, when the determined deceleration falls below a selected threshold value, the control unit 120 adjusts the fuel flow rate from a first fuel flow rate to a second fuel flow rate to establish a deceleration above the threshold value. In other words, the fuel flow rate is adjusted when the absolute value of the deceleration falls below a selected threshold value. Additionally, the value for the second fuel flow rate can be determined from a comparison of the deceleration and the selected threshold value. When the determined deceleration is above the selected threshold, the processor 120 can continue to adjust the fuel flow rate using the closed-loop feedback from the sensor 130. Alternately, the control unit 120 can adjust the fuel flow rate using a predetermined sequence as in the open-loop shutdown sequence.

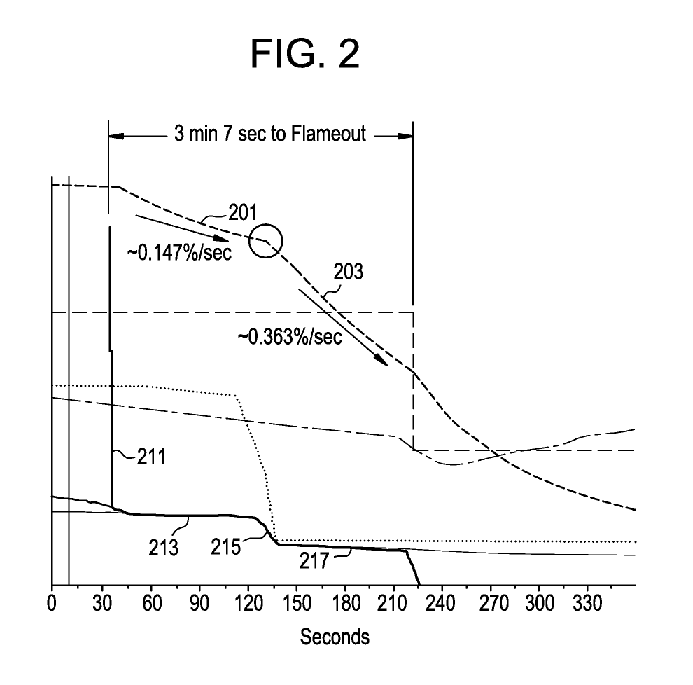

FIG. 2 shows an exemplary graph of various parameters with respect to time of an open-loop shut down sequence of the exemplary generator of FIG. 1. Shutdown begins as fuel flow rate 211 is initially reduced to a first fuel flow rate. Curves 201 and 203 indicate turbine rotation speeds during various time periods of a shut-down sequence. Deceleration rates can be determined from slopes of the curves. Curve 201 indicates a first deceleration rate of ˜0.147%/sec corresponding to a fuel flow rate indicated by fuel flow rate 213. Curve 203 indicates a second deceleration rate of ˜0.363%/sec corresponding to a fuel flow rate indicated by fuel flow rate 217. The fuel flow rate 215 is adjusted to change the deceleration from the deceleration of curve 201 to the deceleration of curve 203. The curve 201 can be seen to flatten out prior to change in the fuel flow rate 215, showing the tendency of curve 201 to “hang.” The time duration of the exemplary open-loop shutdown sequence of FIG. 2 is approximately 3 minutes and 7 seconds.

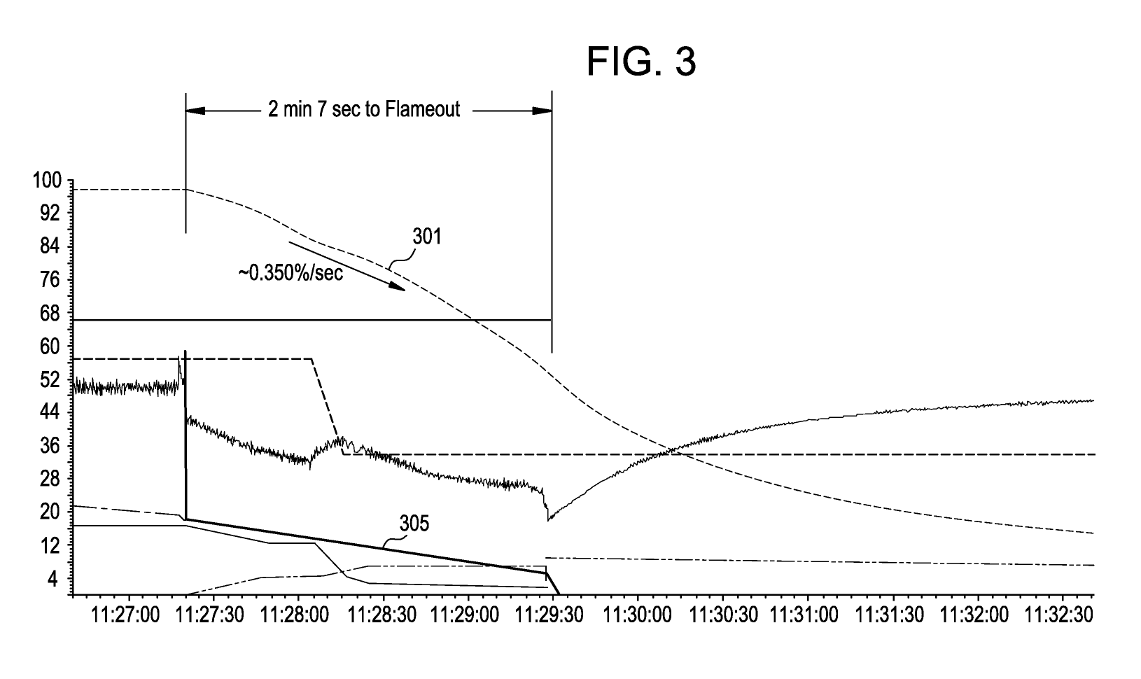

FIG. 3 shows an exemplary graph of various parameters with respect to time for an exemplary closed-loop shut-down sequence of the present disclosure. Curve 301 indicates rotation speeds during the shut-down sequence. Curve 305 indicates a fuel flow rate. Curve 301 maintains a substantially constant deceleration rate of ˜0.350%/sec. Throughout shut-down, the fuel flow rate curve 305 is generally adjusted based on a deceleration rate determined from curve 301. Curve 301 does not exhibit a tendency for hanging, as does the curve 201 of FIG. 2. The time duration of the exemplary closed-loop shutdown sequence of FIG. 3 is approximately 2 minutes and 7 seconds, which is a shorter shut-down than provided by the open-loop shutdown sequence.

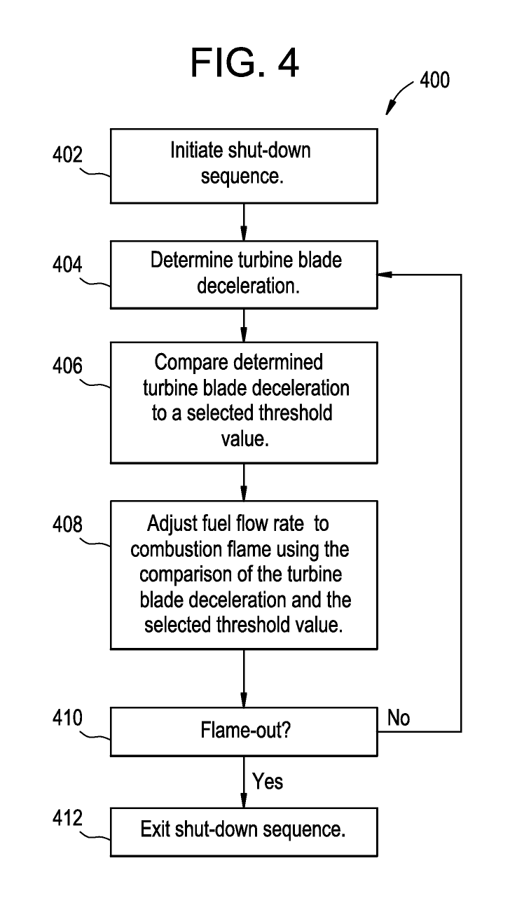

FIG. 4 shows a flowchart of an exemplary method of the present disclosure for shutting down the generator. In Step 402, the shut-down sequence is initiated. At Step 404, a deceleration rate of the turbine rotor is determined In Step 406, the determined deceleration is compared to a selected threshold value. Thus, if the absolute value of the deceleration is less than the selected threshold value, the fuel flow rate is adjusted. In Step 408, the fuel flow rate to the combustion flame is adjusted using the comparison from Step 406. Additionally, the comparison can be used to determine a value for the second fuel flow rate. In Step 410, the combustor is monitored to determine if the combustion flame is still burning or if the flame has undergone flame-out. If combustion flame is still burning, the shut-down sequence returns to Step 404 to determine another deceleration. If flame-out has occurred, the shut-down sequence is exited at Step 412.

Therefore, in one aspect, the present disclosure provides a method of controlling a flow of fuel during a shut down of a gas turbine generator, including: setting a first fuel flow rate to a combustion flame of the gas turbine generator; determining a deceleration of a turbine rotor of the gas turbine generator corresponding to the first fuel flow rate; comparing the deceleration to a selected criterion; and adjusting the first fuel flow rate to a second fuel flow rate when the deceleration matches the selected criterion to control the flow of fuel. In one embodiment, the selected criterion is a threshold value of the deceleration and the first fuel flow rate is adjusted to the second fuel flow rate when the determined deceleration falls below the threshold value. When the deceleration is above the threshold value, the fuel flow rate can be altered according to a predetermined sequence. In addition, the comparison of the deceleration and the selected criterion can be used to determine a value of the second fuel flow rate. The combustion flame typically creates a working gas for rotating the turbine rotor. The fuel flow rate can be reduced substantially to zero at a flame-out of the combustion flame.

In another aspect, the present disclosure provides a system for controlling a flow of fuel during a shut down of a gas turbine generator, the system including a sensor configured to measure a rotation rate of a turbine rotor of the generator; and a processor configured to: determine a deceleration of the turbine rotor from the measured rotation rates corresponding to a first fuel flow rate, compare the determined deceleration to a selected criterion, and adjust the fuel flow rate from a first fuel flow rate to a second fuel flow rate when the deceleration matches the selected criterion to control the flow of fuel. In one embodiment, the selected criterion is a threshold value of the deceleration and the processor is further configured to adjust the fuel flow rate when the determined deceleration falls below the threshold value. The processor can be further configured to alter the fuel flow rate according to a predetermined sequence when the deceleration is above the threshold value. The processor can be further configured to determine a value of the second fuel flow rate from the comparison of the deceleration and the selected criterion. The fuel flows to a combustion flame that creates a working gas that rotates the turbine rotor. When the combustion flame experiences flame-out, the processor reduces the fuel flow rate substantially to zero.

In another aspect, the present disclosure provides a generator that includes: a turbine section having a rotor having a plurality of turbine blades; a combustor configured to burn a fuel to produce a working gas for rotating the rotor of the turbine section; and a processor configured to: set a first fuel flow rate at the combustor during a shut-down sequence of the generator, determine a deceleration of the rotor at the first fuel flow rate, compare the determined deceleration to a selected criterion, and adjust the first fuel flow rate to a second fuel flow rate when the determined deceleration matches the selected criterion. In one embodiment, the selected criterion is a threshold value of the deceleration and the processor is further configured to adjust the first fuel flow rate to the second fuel flow rate when the determined deceleration falls below the threshold value. The processor can be configured to alter the fuel flow rate according to a predetermined sequence when the deceleration is above the threshold value. The processor can be further configured to determine a value of the second fuel flow rate from the comparison of the deceleration and the selected criterion. The fuel flow rate can be reduced substantially to zero at a flame-out of a combustion flame in the combustor.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of controlling a flow of fuel during a shut down of a gas turbine generator, comprising:
setting a first fuel flow rate to a combustion flame of the gas turbine generator;
determining a deceleration of a turbine rotor of the gas turbine generator corresponding to the first fuel flow rate;
comparing the deceleration to a selected criterion; and
adjusting the first fuel flow rate to a second fuel flow rate when the deceleration matches the selected criterion to control the flow of fuel.

2. The method of claim 1, wherein the selected criterion is a threshold value of the deceleration, further comprising adjusting the first fuel flow rate to the second fuel flow rate when the determined deceleration falls below the threshold value.

3. The method of claim 2, further comprising altering the fuel flow rate according to a predetermined sequence when the deceleration is above the threshold value.

4. The method of claim 1, further comprising determining a value of the second fuel flow rate from the comparison of the deceleration and the selected criterion.

5. The method of claim 1, wherein the combustion flame creates a working gas for rotating the turbine rotor.

6. The method of claim 1, further comprising reducing the fuel flow rate substantially to zero at a flame-out of the combustion flame.

7. A system for controlling a flow of fuel during a shut down of a gas turbine generator, comprising:
a sensor configured to measure a rotation rate of a turbine rotor of the generator; and
a processor configured to:
determine a deceleration of the turbine rotor from the measured rotation rates corresponding to a first fuel flow rate,
compare the determined deceleration to a selected criterion, and
adjust the fuel flow rate from a first fuel flow rate to a second fuel flow rate when the deceleration matches the selected criterion to control the flow of fuel.

8. The system of claim 7, wherein the selected criterion is a threshold value of the deceleration and the processor is further configured to adjust the fuel flow rate when the determined deceleration falls below the threshold value.

9. The system of claim 8, wherein the processor is further configured to alter the fuel flow rate according to a predetermined sequence when the deceleration is above the threshold value.

10. The method of claim 7, wherein the processor is further configured to determine a value of the second fuel flow rate from the comparison of the deceleration and the selected criterion.

11. The system of claim 7, wherein the fuel flows to a combustion flame that creates a working gas that rotates the turbine rotor.

12. The system of claim 10, wherein the processor is further configured to reduce the fuel flow rate substantially to zero at a flame-out of the combustion flame.

13. A generator, comprising:
a turbine section having rotor having a plurality of turbine blades;
a combustor configured to combust a fuel to produce a working gas for rotating the rotor of the turbine section; and
a processor configured to:
set a first fuel flow rate at the combustor at during a shut-down sequence of the generator
determine a deceleration of the rotor at the first fuel flow rate,
compare the determined deceleration to a selected criterion, and
adjust the first fuel flow rate to a second fuel flow rate when the determined deceleration matches the selected criterion.

14. The generator of claim 13, wherein the selected criterion is a threshold value of the deceleration and the processor is further configured to adjust the first fuel flow rate to the second fuel flow rate when the determined deceleration falls below the threshold value.

15. The generator of claim 14, wherein the processor is further configured to alter the fuel flow rate according to a predetermined sequence when the deceleration is above the threshold value.

16. The generator of claim 13, wherein the processor is further configured to determine a value of the second fuel flow rate from the comparison of the deceleration and the selected criterion.

17. The generator of claim 13, further comprising reducing the fuel flow rate substantially to zero at a flame-out of a combustion flame in the combustor.
